(19) United States
(12) Patent Application Publication
(10) Pub. No.: US 2006/0063966 A1
(43) Pub. Date: Mar. 23, 2006

(54) Patient isolation bed

(76) Inventors: Daniel W.T. Chan, Kowloon (HK); Thomas K.S. Wong, Kowloon (HK); Henry K.C. Mak, Kowloon (HK)

Correspondence Address: JACOBSON HOLMAN PLLC, 400 SEVENTH STREET N.W., SUITE 600, WASHINGTON, DC, 20004, US

(21) Appl. No.: 10/943,233

(22) Filed: Sep. 17, 2004

(51) Int. Cl. A61G 10/00

(52) U.S. Cl. 600/21

(57) ABSTRACT

An isolation unit for a patient bed is provided. The bed has a platform, atop which a patient may rest. The isolation unit firstly includes a frame having an upper frame positioned above the platform and a lower frame formed in a perimeter of or positioned around the platform. The bed further includes at least one air supplier on the upper or lower frame for supplying air towards the lower or upper frame respectively to form an air curtain, and at least one air extractor positioned on the lower or upper frame respectively for extracting the air to increase the strength of the air curtain. The air curtain extends between the upper frame and the lower frame and at least partly defines a space between the upper frame and the platform.

### BACKGROUND

1. Field of the Invention

The present invention relates to technologies for isolating patients for infection control.

2. Background of the Invention

Isolation of patients may be desirable, especially for those with high risks of infection through the air. Physical barrier is one solution. However, this would cause not only inconvenience to the healthcare workers, but also uncomfortable environment for the patients themselves.

Huszar, O. I., Air Curtain for Patient Isolation, IAMA, Vol 207, No 3, Jan. 20, 1969, discloses the use of airflow at a high velocity to produce an air curtain around a patient bed for isolation of the patient.

Disadvantages exist with this design. Firstly, control of the airflow is limited, which may result in unsatisfactory control of the air curtain. This may consequently affect the effectiveness of the isolation of the patient adversely. Furthermore, this design fails to teach how to avoid cross contamination caused by the air within the patient's zone.

### OBJECT OF THE INVENTION

Therefore, it is an object of the present invention to provide an improved patient isolation solution, which is more effective, or at least provide the public with a useful choice.

### SUMMARY OF THE INVENTION

According to an aspect of the present invention, an isolation unit for a patient bed is provided. The bed has a platform, atop which a patient may rest. The isolation unit firstly includes a frame having an upper frame positioned above the platform and a lower frame formed in a perimeter of or positioned around the platform. The bed further includes at least one air supplier on the upper or lower frame for supplying air towards the lower or upper frame respectively to form an air curtain, and at least one air extractor positioned on the lower or upper frame respectively for extracting the air to increase the strength of the air curtain. The air curtain extends between the upper frame and the lower frame and at least partly defines a space between the upper frame and the platform.

According to another aspect of the present invention, a process for isolating a patient bed is provided. The bed has a frame with a platform, an upper frame above the platform having one side and a lower frame around the platform having one side corresponding to said one side of the upper frame. Air is directed from an air supplier on said one side of the upper or lower frame towards the lower or upper frame respectively for forming an air curtain at least partly defining a space between the platform and the upper frame. In addition, the air is extracted by an air extractor positioned on said one corresponding side of the lower or upper frame respectively such that the air curtain extends between said one side of the upper frame and said one corresponding side of the lower frame so as to at least partly define a space between the platform and the upper frame.

According to a further aspect of the present invention, a ward includes
at least two patient beds spaced from each other,
wherein each bed includes a platform, atop which a patient may rest and an isolation unit, and
wherein the isolation includes
   a frame, including
      an upper frame positioned above the platform; and
      a lower frame formed in a perimeter of or positioned around the platform;
   at least one air supplier on the upper or lower frame for supplying air towards the lower or upper frame respectively to form an air curtain; and
   at least one air extractor positioned on the lower or upper frame respectively for extracting the air to increase the strength of the air curtain, wherein the air curtain extends between the upper frame and the lower frame and at least partly defines a space between the upper frame and the platform.

Preferably, there can be an output for outputting at least part of the analysis result by the processor.

Other aspects and advantages of the invention will become apparent from the following detailed description, taken in conjunction with the accompanying drawings, which description illustrates by way of example the principles of the invention.

### BRIEF DESCRIPTION OF THE DRAWINGS

FIG. 1 is a perspective view of a patient bed according to an exemplary embodiment of the present invention; and

FIG. 2 is a top plan view of a ward according to an exemplary embodiment of the present invention.

### DETAILED DESCRIPTION

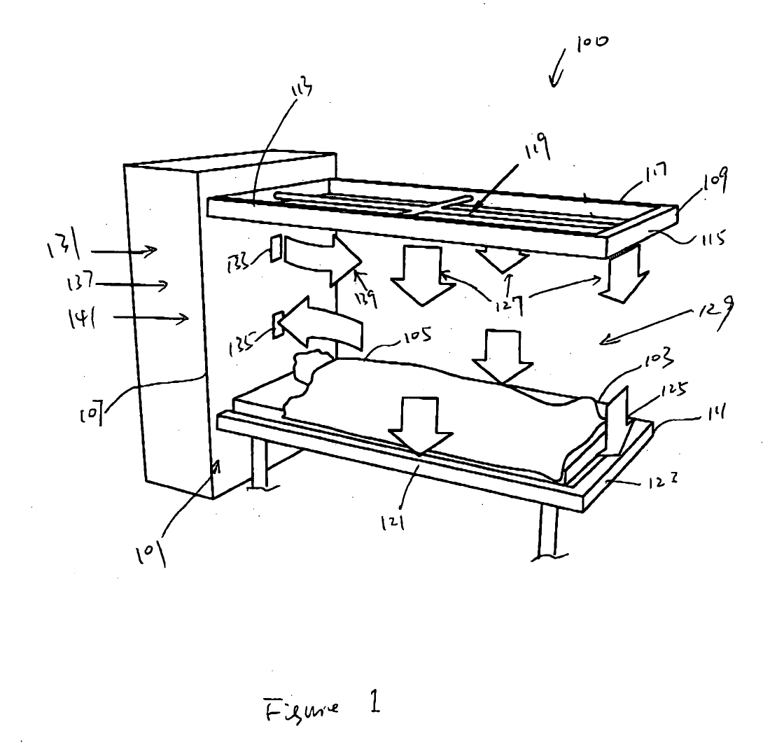

As shown in FIG. 1, a patient isolation bed 100 according to an exemplary embodiment of the present invention has a frame generally indicated as 101. The frame has a platform 103, atop which a patient 105 may rest, as generally understood in the art. A wall 107 extending substantially perpendicular to the platform 103 at one end of the bed 100 is also provided.

Furthermore, the frame 103 has an upper frame 109 and a lower frame 111, both slightly wider than the platform 103. In addition, the upper and lower frames 109, 111 extend substantially parallel to the platform 103 and are connected to the wall 107 at the end of the bed 100. The upper frame 109 has three sides 113, 115, 117 sequentially connected to each other to, which together with the wall 107, define a cover 119 above the platform 103. The lower frame also has three sequentially connected sides 121, 123, 125 substantially opposite to the three sides of the upper frame 109 respectively. In the exemplary embodiment, the lower frame 11 can simply have the three sides connected to and surrounding the platform 103. It should be noted that the lower frame and platform may be substantially a single frame and base for the bed.

Air supply slots (not shown) arranged circumferentially are created on the three sides 113, 115, 117 of the upper frame respectively for directing air 127 at a high velocity, for example, 0.2 m/s-2.0 m/s towards the corresponding circumferential sides of the lower frame 111. In this way, an air curtain (not shown) can be formed extending between the sides of the upper frame 109 and the sides of the lower frame 111 and thereby defines a space, or a patient zone 129 between the upper frame 111 and the platform 103. This patient zone 129 is isolated from the outside environment by such an air curtain, together with the wall 107, the platform 103 and the cover 119 of the upper frame 109 in this exemplary embodiment. Isolation of the patient 105 on the platform 103 can therefore be achieved. It is understood that the bed 100 has an air supply mechanism (not shown) built therein for supplying air to the air supply slots for forming the air curtain. It should be noted that the airflow in the exemplary embodiment is from the upper platform to the lower although the reverse direction is also possible.

Air extractors (not shown) arranged circumferentially are provided on the three sides 121, 123, 125 of the lower frame 111 respectively for extracting the air, which comes from the upper frame 109 forming the air curtain. The air extractors are positioned substantially opposite to the air supply slots respectively in the exemplary embodiment. Thus, the strength of the air curtain is substantially strengthened in that the air curtain can thereby maintain a relatively high pressure as compared to the environmental air pressures all the way from the upper frame to the lower frame. As a result, the air curtain acts more effectively to prevent air penetrating therethrough, either from the patient zone to the outside environment or from the outside environment into the patient zone. The isolation effectiveness can therefore be substantially improved.

With the air being extracted, there is less spread of the air as it approaches the lower frame, which assists maintaining a neutral pressure within the patient zone 129. This brings the benefit that the patient 105 may breathe more comfortably.

In the exemplary embodiment, both the air supply slots and the air extractors may extend along the three sides of the upper frame 109 and lower frame 111 respectively. In this way, the air curtain extends all the way along the sides of the patient bed to increase the isolation effectiveness. It should be noted that the air supply and extractors could be switched to work from the lower platform to extraction at the upper platform.

Air collected by the air extractors can be recycled and supplied to the air supply slots for forming the air curtain. A disinfection system, for example, an ultraviolet lamp 131 can be provided on the recycle path (not shown) for cleaning the recycled air.

A clean air supply slot 133 and a clean air extraction slot 135 are created on the wall 107, A clean air supply mechanism (generally indicated as 137), separate from the air supply mechanism for forming the air curtain, can be provided behind the wall 107 for supplying clean air 139 into the patient zone 129 through the clean air supply slot 133. The clean air supply is designed such that the clean air 139 is directed into the patient zone 129 at a relatively slow velocity such that it hardly changes the air pressure within the patient zone 129. This creates a neutral pressure zone air in the patient zone 129, prevents the air curtain, and thereby avoids affecting the isolation of the patient bed 100 by the air curtain. This individual ventilation also has the dilution effect to the microbiological pollutants produced by the patients.

A filter 141 is also provided behind the wall 107 workable with the extraction slot 135 for filtering the clean air flowing out of the patient zone 129 through the extraction slot 135. This helps to reduce contamination of the environment by the air coming out from the patient zone 129.

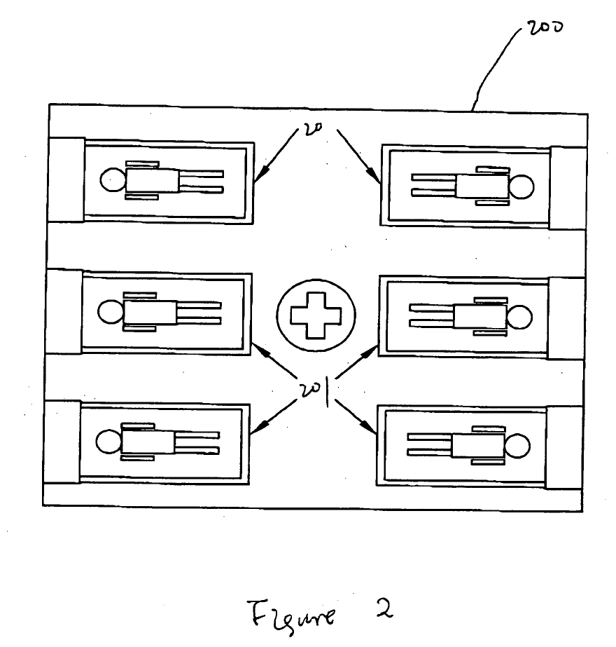

FIG. 2 illustrates a ward 200 according to an exemplary embodiment of the present invention. More than one patient isolation beds as described above with reference to FIG. 1 are provided in the ward, each distanced from each other and having individual air supply systems. In this way, cross contamination between the patients in this ward can be substantially reduced, if not eliminated.

What is claimed is:

1. An isolation unit for a patient bed, the bed having a platform, atop which a patient may rest, comprising:
a frame, including
an upper frame positioned above the platform; and
a lower frame formed in a perimeter of or positioned around the platform;
at least one air supplier on the upper or lower frame for supplying air towards the lower or upper frame respectively to form an air curtain; and
at least one air extractor positioned on the lower or upper frame respectively for extracting the air to increase the strength of the air curtain, wherein the air curtain extends between the upper frame and the lower frame and at least partly defines a space between the upper frame and the platform.

2. The isolation unit of claim 1, wherein the upper frame is wider than the platform in size.

3. The isolation unit of claim 2, wherein the lower frame has a size at least substantially the same as the upper frame.

4. The isolation unit of claim 3, wherein the lower frame is positioned at least substantially opposite to the upper frame.

5. The isolation unit of claim 4, wherein the air extractor is positioned at least substantially opposite to the air supplier.

6. The isolation unit of claim 1, wherein the upper frame has at least one side with an air supplier thereon, and wherein the lower frame has at least one corresponding side with an air extractor thereon such the air curtain extends from said one side of the upper frame to said one corresponding side of the lower frame.

7. The isolation unit of claim 6, wherein air supplier and the air extractor are designed such that the space at least partly defined by the air curtain maintains a neutral pressure.

8. The isolation unit of claim 1, wherein the upper frame has three sides with at least three air suppliers on each side respectively, and wherein the lower frame has three corresponding sides with at least three corresponding air extractors created on each side respectively such the air curtain has three sides, each extending from a side of the upper frame to a corresponding side of the lower frame.

9. The isolation unit of claim 1, further comprising
a clean air supply for supplying clean air into the space defined by the air curtain.

10. The isolation unit of claim 9, wherein the air supplier and the clean air supply are designed such that the air curtain has a pressure substantially lager than the pressure of the clean air flowing into the space through the clean air supply.

11. The isolation unit of claim 9, wherein the upper frame has at least one side with the air supplier thereon, and wherein the lower frame has at least one corresponding side with the air extractor thereon such the air curtain extends from said one side of the upper frame to said one corresponding side of the lower frame.

12. The isolation unit of claim 11, wherein the air supplier and the air extractor are designed such that the space at least partly defined by the air curtain maintains a neutral pressure and such that the clean air supplied by the clean air supply is restricted from penetrating the air curtain.

13. The isolation unit of claim 12, comprising an extraction slot through which the clean air supplied by the clean air supply can flow through out of the space at least partly defined by the air curtain.

14. The isolation unit of claim 13, comprising a filter workable with the extraction slot for filtering the clean air flowing out of the space through the extraction slot.

15. The isolation unit of claim 14, wherein the upper frame, the platform and the lower frame extends at least substantially parallel to each other.

16. The isolation unit of claim 15, comprising a wall extending substantially perpendicular to the platform from at least the upper frame to the lower frame, at an end of the platform.

17. The isolation unit of claim 16, wherein both the clean air supply and the extraction slot are created on the wall at positions above the platform.

18. The isolation unit of claim 1, wherein the air forming the air curtain is recycled, further comprising an ultraviolet disinfection system positioned on the recycling path of the air forming the air curtain for clean purpose.

19. A process for isolating a patient bed, the bed having a frame with a platform, an upper frame above the platform having one side and a lower frame around the platform having one side corresponding to said one side of the upper frame, comprising
directing air from an air supplier on said one side of the upper or lower frame towards the lower or upper frame respectively for forming an air curtain at least partly defining a space between the platform and the upper frame; and
extracting the air by an air extractor positioned on said one corresponding side of the lower or upper frame respectively such that the air curtain extends between said one side of the upper frame and said one corresponding side of the lower frame so as to at least partly define a space between the platform and the upper frame.

20. The process of claim 19, comprising
supplying clean air into the space through a clean air supply different from the air supply slot on the upper frame.

21. A ward, comprising:
at least two patient beds spaced from each other,
wherein each bed includes a platform, atop which a patient may rest and an isolation unit, and
wherein the isolation includes
a frame, including
an upper frame positioned above the platform; and
a lower frame formed in a perimeter of or positioned around the platform;
at least one air supplier on the upper or lower frame for supplying air towards the lower or upper frame respectively to form an air curtain; and
at least one air extractor positioned on the lower or upper frame respectively for extracting the air to increase the strength of the air curtain, wherein the air curtain extends between the upper frame and the lower frame and at least partly defines a space between the upper frame and the platform.

22. The ward of claim 21, wherein said each isolation unit further includes a clean air supply different from the air supplier on the upper frame for supplying clean air into the space at least partly defined by the air curtain.
